(19) United States
(12) Patent Application Publication
(10) Pub. No.: US 2021/0204473 A1
(43) Pub. Date: Jul. 8, 2021

(54) AUTONOMOUS LAWNMOWER AND STEERING METHOD THEREOF

(71) Applicant: Positec Power Tools (Suzhou) Co., Ltd., Jiangsu (CN)

(72) Inventors: Paolo ANDRIOLO, Vicenza (IT); Davide DALFRA, Vicenza (IT)

(21) Appl. No.: 17/056,348

(22) PCT Filed: May 22, 2019
(86) PCT No.: PCT/CN2019/087989

§ 371 Date: Nov. 17, 2020

(30) Foreign Application Priority Data
May 22, 2018 (CN) 201810497076.8

(51) Int. Cl. A01D 34/00

(52) U.S. Cl. CPC A01D 34/008; A01D 2101/00

(57) ABSTRACT

The present invention relates to an autonomous lawnmower, walking and working in a working area, and including: a housing, a walking module, and a surface recognition module, a detection area of the surface recognition module including a surface in front of the walking module, a boundary of the working area being formed between the working surface and the non-working surface; and a control module, determining a position relationship between the autonomous lawnmower and the boundary according to a signal sent by the surface recognition module, if a preset position relationship is met, enabling the walking module to perform steering to travel into the working area, where if a moving direction forms an acute angle with the boundary in the clockwise direction, steering is clockwise, so that when steering is completed, the moving direction forms an acute angle with the boundary in the clockwise direction, and vice versa.

This application is a National Stage Application of International Application No. PCT/CN2019/087989, filed on May 22, 2019, which claims benefit of and priority to Chinese Patent Application No. 201810497076.8, filed on May 22, 2018, all of which are hereby incorporated by reference in their entirety for all purposes as if fully set forth herein.

### BACKGROUND

### Technical Field

The present invention relates to the field of intelligent control, and in particular, to an autonomous lawnmower and a steering method thereof.

### Related Art

An autonomous lawnmower is a robot that uses sensors to sense a surrounding environment and its own status, perceives and determines a complex environment, and makes decisions and plans accordingly to implement a target-oriented movement, so as to complete a particular task. The autonomous lawnmower may run by receiving an instruction from a user or may run automatically according to a run program.

Generally, the autonomous lawnmower works within a boundary wire set by the user. The autonomous lawnmower recognizes a boundary of a working area by detecting a signal generated by the boundary wire. When detecting the boundary wire, the autonomous lawnmower starts steering to leave the boundary wire to prevent the autonomous lawnmower from moving and working outside the working area. Most commercial autonomous lawnmowers walk along random paths, that is, travel along straight lines within a working range. When encountering an obstacle or a boundary wire, an autonomous lawnmower first brakes to stop walking, then steers randomly or according to a predetermined program, and then starts to leave. The autonomous lawnmower can only sense that the autonomous lawnmower has encountered an obstacle or a boundary but cannot know its original walking direction and an exact position in the working area. Therefore, the autonomous lawnmower cannot appropriately determine a preferred direction in which the autonomous lawnmower is to steer next. As a result, the autonomous lawnmower can only randomly move in a narrow area and it takes a long time for the autonomous lawnmower to leave the area, or the autonomous lawnmower may even fail to leave the area, causing increased mechanical wear to an autonomous walking device and a shorter service life.

It is complex and inconvenient for a user to arrange the boundary wire. The user needs to arrange the boundary wire at a distance from an actual boundary according to the guidance of the manual, so as to prevent the autonomous lawnmower from walking beyond a safety boundary and ensure the working safety. If the boundary wire is not arranged, a boundary of the working area may be directly adjacent to a dangerous area, and the autonomous lawnmower cannot be far away from the dangerous area through user settings. As a result, danger may occur when the autonomous lawnmower approaches the dangerous area or during steering, leading to a fault.

### SUMMARY

To overcome disadvantages in the prior art, the problem to be resolved in the present invention is to provide a boundary-less autonomous lawnmower with a safe and efficient steering process.

A technical solution adopted in embodiments of the present invention to resolve problems in the prior art is as follows:

An autonomous lawnmower is provided, walking and working in a working area. The autonomous lawnmower includes: a housing, including a front portion in a moving direction of the autonomous lawnmower; a walking module, mounted in the housing, driving the autonomous lawnmower to walk and steer; a surface recognition module, mounted in the housing, and detecting a surface walked by the autonomous lawnmower, a detection area of the surface recognition module including a surface in front of the walking module, a surface in the working area being a working surface, a surface outside the working area being a non-working surface, a boundary of the working area being formed between the working surface and the non-working surface; an energy module, mounted in the housing, supplying energy to the autonomous lawnmower; and a control module, electrically connected to the walking module and the surface recognition module, determining a position relationship between the autonomous lawnmower and the boundary according to a signal sent by the surface recognition module, if a preset position relationship is met, enabling the walking module to perform steering to travel into the working area, where if the moving direction forms an acute angle with the boundary in the clockwise direction, steering is clockwise, so that when steering is completed, the moving direction forms an acute angle with the boundary in the clockwise direction, and if the moving direction forms an obtuse angle with the boundary in the clockwise direction, steering is counterclockwise, so that when steering is completed, the moving direction forms an obtuse angle with the boundary in the clockwise direction.

In one of the embodiments, the surface recognition module recognizes a lawn.

In one of the embodiments, the surface recognition module includes a surface recognition sensor, and the surface recognition sensor includes least one of an optical sensor, a radar sensor, a capacitive sensor, and an image sensor.

In one of the embodiments, during steering, the control module controls the walking module to keep walking in the working area.

In one of the embodiments, a distance by which the detection area exceeds the walking module is greater than or equal to a first preset distance.

In one of the embodiments, the first preset distance is between 20 cm and 80 cm.

In one of the embodiments, an angle between a detection angle of the surface recognition sensor and the height direction is less than 75 degrees and greater than 30 degrees.

In one of the embodiments, according to a signal that is sent by the surface recognition module and indicates that the non-working surface is detected, the control module controls the walking module to reverse a second preset distance and then steer.

In one of the embodiments, the surface recognition module includes least one of a surface recognition sensor, and a detection area of the surface recognition sensor is symmetric with respect to an axis in the moving direction.

In one of the embodiments, the surface recognition module includes an image sensor, and the control module determines an angle relationship between the moving direction and the boundary in the clockwise direction according to a relative relationship, detected by the image sensor, between the axis and the boundary.

In one of the embodiments, the surface recognition module includes at least two surface recognition sensors symmetrically disposed with respect to an axis in the moving direction.

In one of the embodiments, if a surface recognition sensor on the left side of the axis first detects the non-working surface, the control module determines that the moving direction forms an acute angle with the boundary in the clockwise direction; and if a surface recognition sensor on the right side of the axis first detects the non-working surface, the control module determines that the moving direction forms an obtuse angle with the boundary in the clockwise direction.

In one of the embodiments, an angle of steering is less than 180 degrees and greater than or equal to 90 degrees.

In one of the embodiments, the autonomous lawnmower includes at least two drive wheels, each drive wheel is connected to an independent drive motor, and during steering, the drive motors drive the two drive wheels at different speeds or in different directions.

Another technical solution adopted in embodiments of the present invention to resolve problems in the prior art is as follows:

A steering method of an autonomous lawnmower is provided, where the autonomous lawnmower is configured to walk and work in a working area defined by a boundary formed by a lawn and a non-lawn, a surface in the working area is a lawn, and the method includes the following steps: traveling, by the autonomous lawnmower, to the boundary; detecting a surface walked by the autonomous lawnmower; determining a position relationship between the autonomous lawnmower and the boundary based on the detection of a non-lawn; and determining an angle relationship between the autonomous lawnmower and the boundary when the position relationship between the autonomous lawnmower and the boundary meets a preset position relationship, where steering is controlled according to the angle relationship to enable the autonomous lawnmower to travel into the working area, if a moving direction of the autonomous lawnmower forms an acute angle with the boundary in the clockwise direction, steering is clockwise, so that when steering is completed, the moving direction forms an acute angle with the boundary in the clockwise direction, and if the moving direction forms an obtuse angle with the boundary in the clockwise direction, steering is counterclockwise, so that when steering is completed, the moving direction forms an obtuse angle with the boundary in the clockwise direction.

In one of the embodiments, after steering is started and before steering is completed, the autonomous lawnmower walks a second preset distance along an inner side of the boundary.

In one of the embodiments, the second preset distance is between 20 cm and 100 cm.

Compared with the prior art, the embodiments of present invention has the following beneficial effects:

When no boundary wire is arranged on a boundary of a working area of an autonomous lawnmower, an angle relationship between the autonomous lawnmower and the boundary is determined by detecting a surface in front of the autonomous lawnmower, so that a walking module of the autonomous lawnmower can start steering without moving beyond the boundary. A steering manner is determined according to an angle relationship between a moving direction of the autonomous lawnmower and the boundary in the clockwise direction at the beginning of steering, so that when steering is completed, the angle relationship between the moving direction of the autonomous lawnmower and the boundary in the clockwise direction is still an obtuse angle consistent with the obtuse angle relationship at the beginning of steering, or is still an acute angle consistent with the acute angle at the beginning of steering. In this way, the autonomous lawnmower can keep walking in the working area and move from one area to another area during steering, but does not repeatedly work in the same area, thereby improving the working efficiency while ensuring safety.

### BRIEF DESCRIPTION OF THE DRAWINGS

The foregoing objects, technical solutions, and beneficial effects of embodiments of the present invention can be implemented with reference to the accompanying drawings below:

FIG. 1 is a schematic diagram of an autonomous working system according to an embodiment of the present invention.

FIG. 2 is a schematic structural diagram of an autonomous lawnmower according to an embodiment of the present invention.

FIG. 3 is a schematic structural diagram of an autonomous lawnmower according to an embodiment of the present invention.

FIG. 4 is a diagram of path selection of an autonomous lawnmower according to an embodiment of the present invention.

FIG. 5 is a diagram of path selection of an autonomous lawnmower according to an embodiment of the present invention.

FIG. 6 is a diagram of path selection of an autonomous lawnmower according to an embodiment of the present invention.

FIG. 7 is a diagram of path selection of an autonomous lawnmower passing through a narrow area according to an embodiment of the present invention.

FIG. 8 is another diagram of path selection of an autonomous lawnmower passing through a narrow area according to an embodiment of the present invention.

### DETAILED DESCRIPTION

Specific implementations of the present invention are described below in detail with reference to the accompanying drawings.

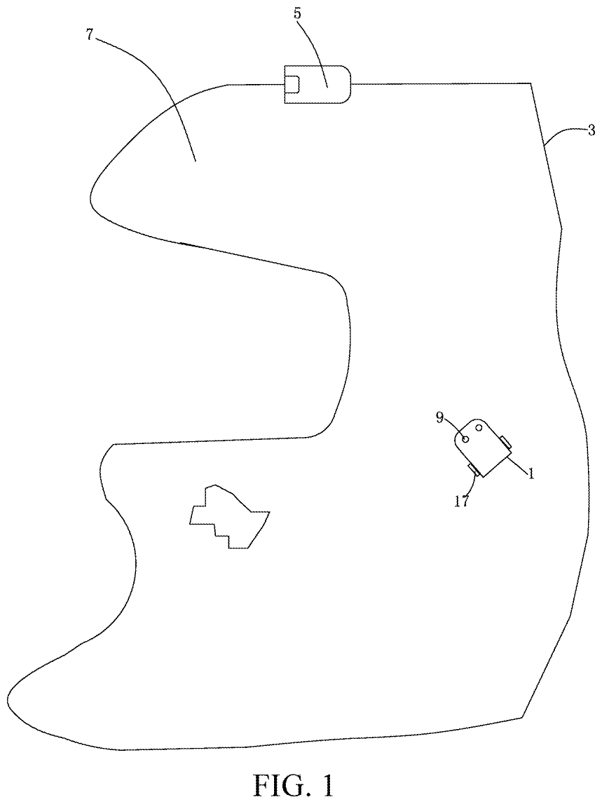

As shown in FIG. 1, in an embodiment of the present invention, an autonomous working system includes an autonomous lawnmower 1 and a base station 5. The autonomous lawnmower 1 walks and works in a working area 7. The base station 5 is used for parking the autonomous lawnmower. Especially, the autonomous lawnmower 1 returns to replenish energy when the energy is insufficient. The autonomous lawnmower 1 includes a walking module 17, a working module, an energy module 33, a control module 19, and the like.

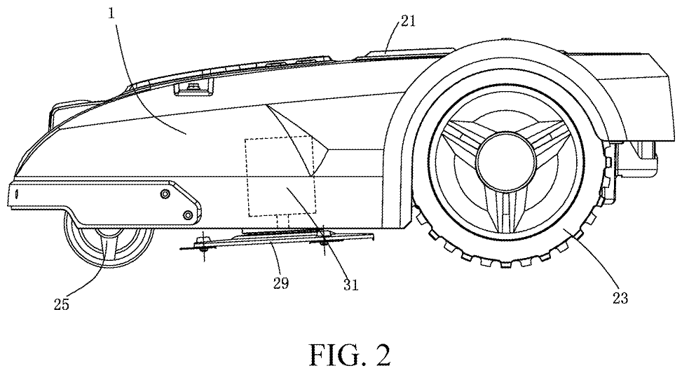

As shown in FIG. 2, the walking module 17 is configured to drive the autonomous lawnmower 1 to walk in the working area 7, and is usually formed by a wheel set mounted on the autonomous lawnmower 1 and a walking motor for driving the wheel set. In this embodiment, the walking module 17 includes a wheel set mounted below the housing. The wheel set includes two drive wheels 23 respectively located on both sides in the rear of a housing 21. The wheel set also includes two auxiliary wheels 25 respectively located on both sides in the front of the housing 21. The walking module 17 further includes a drive motor connected to the drive wheel. The drive motor is responsible for driving the drive wheel 23 to rotate to drive the autonomous lawnmower 1 to walk, and the drive motor is further responsible for driving the drive wheel 23 to steer. In the autonomous lawnmower 1, each of the two drive wheels 23 is independently connected to one drive motor. The rotational speed of the drive motor is controlled by a control module 19. When the control module 19 instructs the two drive motors to rotate at the same speed and in the same direction, the autonomous lawnmower 1 walks along a straight line. When the control module 19 instructs the two drive motors to rotate at different speeds or in different directions, the autonomous lawnmower 1 steers, and the autonomous lawnmower 1 steers to the side of a drive wheel with a slower rotational speed or steers to the side of a drive wheel with a rotation direction being correspondingly backward. In some embodiments, the wheel set only includes drive wheels connected to the walking motor. For example, four drive wheels are respectively located at the front portion and the rear portion of the autonomous lawnmower, and each drive wheel is connected to one walking motor.

The working module is configured to perform a specific task of the autonomous lawnmower 1. In this embodiment, the working module includes a cutting assembly 29 mounted below the housing 21 and a cutting motor 31 driving the cutting assembly 29 to mow a lawn. The cutting assembly 29 may be a blade connected to a mowing output shaft or a combination of a cutting deck and a blade connected to a mowing output shaft. The specific structure and possible form of the cutting assembly are well known in the industry. Details are not described herein again.

An energy module 33 is configured to supply energy for various work of the autonomous lawnmower 1, and includes a rechargeable battery and a charging connection structure. The charging connection structure may be electrically connected to a charging docking structure on the base station 5, thereby implementing charging. In this embodiment, the energy module 33 is a rechargeable battery located in the housing 21 and a charging plate connected to the rechargeable battery. The charging plate is located in a front portion of the housing and exposed from the housing 21 and is used for being docked to a corresponding charging plate of the base station 5 when the autonomous lawnmower 1 enters the base station 5 to charge the autonomous lawnmower 1. In some embodiments, the charging docking structure may be an inductive wireless docking structure or the like.

The control module 19 is configured to control the autonomous lawnmower 1 to walk and work automatically. In this embodiment, the control module 19 is located in the housing 21 and includes a microcontroller, a memory, and the like. The memory is configured to store a working program of the autonomous lawnmower 1, related parameters in a working process of the autonomous lawnmower 1, information sent back by various sensors and other modules, and the like. The microcontroller is configured to receive a signal sent by another system and calculate and send a corresponding work instruction to each module according to a program built in the memory.

In this embodiment, a surface walked by the autonomous lawnmower 1 in the working area 7 is a working surface. The working surface is mainly a lawn, and may include barks, fallen leaves, and other objects in a garden. A boundary 3 of the working area 7 is formed by a boundary between the working surface and a non-working surface. The autonomous lawnmower 1 recognizes the working surface and the non-working surface by detecting a surface walked by the autonomous lawnmower, so as to recognize the boundary 3 of the working area 7, prevent the autonomous lawnmower from walking beyond the working area 7, and ensure the working safety. The boundary 3 includes an outer boundary of the working area 7. The boundary 3 is usually a closed loop and is surrounded by the non-working surface. The boundary 3 further includes obstacles such as slopes, stones, and trees in the working area 7. In other embodiments, for the obstacles in the working area 7, the control module 19 performs independent control by using a detection signal of an obstacle detection module.

In this embodiment, the autonomous lawnmower 1 includes a surface recognition module 9 for detecting the surface walked by the autonomous lawnmower 1. The surface recognition module 9 may specifically include detection apparatuses such as an optical sensor, a radar sensor, a capacitive sensor, and an image sensor. The sensors have various detection principles and recognition manners, and various quantities of sensors may be disposed at various positions, which is related to a path planning manner. Therefore, details are described below in detail with reference to specific embodiments and the path planning manner.

Generally, the autonomous lawnmower 1 cruises and mows in the working area 7. Under a normal condition, the autonomous lawnmower 1 walks along a straight line until it is detected that the autonomous lawnmower 1 encounters the boundary 3. If the autonomous lawnmower 1 encounters the boundary 3, the autonomous lawnmower 1 changes a walking direction to leave the boundary 3 and return to the working area 7 to continue walking along a straight line until the autonomous lawnmower encounters the boundary 3 again. In the foregoing manner of moving back and forth in the boundary 3, the entire working area 7 is covered for working. When the battery level of the autonomous lawnmower 1 reaches a preset battery level or needs to return to the base station 5 under other circumstances, the control module 19 controls the autonomous lawnmower 1 to look for the base station 5, and returns in a manner of walking along the boundary 3 or searching for the base station 5 through an external signal, to enable the autonomous lawnmower to be docked to the base station 5 for charging or park at the base station 5. In this embodiment, since the boundary 3 is not a physical boundary arranged by a user, the autonomous lawnmower 1 distinguishes the working surface from the non-working surface by recognizing the surface walked by the autonomous lawnmower, thereby indirectly determining the position of the boundary 3 instead of directly recognizing the boundary 3. Therefore, in this embodiment, the detecting, by the surface recognition module 9, the boundary 3 is not specifically directly detecting the boundary 3, and also includes detecting, by the surface recognition module 9, the non-working surface.

In this embodiment, the surface recognition module 9 is mounted in front of the walking module 17. Therefore, when the surface recognition module 9 detects the non-working surface, the walking module 17 is still in the working area 7. It should be understood that when the surface recognition module 9 detects the non-working surface, the front portion of the housing 21 may have already crossed the boundary 3 and entered a non-working area 7, or may be tangent to the boundary 3 in the height direction and has not entered the non-working area 7, or may not have an intersection point with the boundary 3 in the height direction and still be located in the working area 7. Therefore, in this embodiment, the encountering the boundary 3 is not specifically that the autonomous lawnmower 1 has entered the non-working area and is tangent to the boundary 3 in the height direction.

When the autonomous lawnmower 1 is inside the working area 7 far away from the boundary 3, a surface detected by the surface recognition module 9 is a working surface. The autonomous lawnmower 1 definitely encounters the boundary 3 after walking a period of time. At this time, the surface recognition module 9 detects the non-working surface or detects both the working surface and the non-working surface. The control module 19 determines a position relationship between the autonomous lawnmower 1 and the boundary 3 according to a detection signal sent by the surface recognition module 9. After traveling to the boundary 3 and reaching a preset position relationship, the autonomous lawnmower 1 steers to leave the boundary 3, and travels into the working area 7. Specifically, the signal sent by the surface recognition module 9 may represent an angle relationship between the autonomous lawnmower 1 and the boundary 3 or may represent the distance between the autonomous lawnmower 1 and the boundary 3 or may represent which side of the autonomous lawnmower 1 is closer to the boundary 3 or may represent several items of the foregoing content. Such items are related to the type and mounting manner of the surface recognition module 9, processing manners of the control module 19 and the detection signal, and the like.

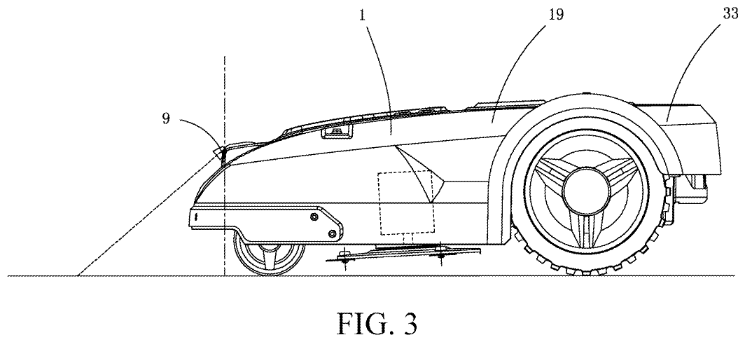

As shown in FIG. 3, in this embodiment, the surface recognition module 9 includes at least one surface recognition sensor. The surface recognition sensor is mounted in the front portion of the housing 21, so that a detection range of the surface recognition sensor includes the front of the walking module 17. In this embodiment, the front is the front in a moving direction of the autonomous lawnmower 1. The walking module 17 includes a drive wheel 23 mounted on the rear side of the housing 21 and an auxiliary wheel 25 mounted on the front side of the housing. Therefore, the detection range of the surface recognition sensor specifically includes a surface in front of the auxiliary wheel 25. Since the boundary 3 of the working area 7 is not formed by a boundary wire arranged by the user, the boundary 3 may be a boundary between a lawn and a road, a boundary between a lawn and a flower bed or a boundary between a lawn and a pool. There is no buffer area between such boundaries. When the auxiliary wheel 25 encounters the boundary 3 or after the auxiliary wheel encounters the boundary 3, the surface recognition sensor detects the boundary 3. When the control module 19 controls the autonomous lawnmower 1 to steer, the auxiliary wheel 25 moves outside the working area 7 during steering, leading to unsafe factors. Therefore, in this embodiment, the surface recognition module 9 is mounted in the front portion of the housing 21, to enable a detection area of the surface recognition module to cover an area in front of the auxiliary wheel 25. The area is not specifically an area adjacent to the auxiliary wheel 25, and may only include a part of a surface in front of the walking module 17 and may be not adjacent to the auxiliary wheel 25. Such an arrangement ensures that the control module 19 recognizes the boundary 3 in advance and controls the auxiliary wheel 25 to make a response, to prevent the autonomous lawnmower 1 from walking outside the working area 7.

Since a surface recognition sensor 11 detects the working surface when the autonomous lawnmower 1 is far away from the inside of the boundary 3, when the autonomous lawnmower 1 is close to the boundary 3, the surface recognition sensor 11 detects the non-working surface in front of the walking module 17. In this embodiment, when a signal that is sent by the surface recognition module 9 and indicates that the non-working surface is detected is received, if the control module 19 determines that the autonomous lawnmower 1 and the boundary 3 meet the preset position relationship, the control module 19 controls the drive wheel 25 to steer. If a moving direction of the autonomous lawnmower 1 forms an acute angle with the boundary 3 in the clockwise direction, the control module 19 controls the drive wheel 25 to steer clockwise, so that when steering is completed, the moving direction of the autonomous lawnmower 1 forms an acute angle with the boundary 3 in the clockwise direction. If the moving direction of the autonomous lawnmower 1 forms an obtuse angle with the boundary 3 in the clockwise direction, the control module 19 controls the drive wheel 25 to steer counterclockwise, so that when steering is completed, the moving direction of the autonomous lawnmower 1 forms an obtuse angle with the boundary 3 in the clockwise direction. In an embodiment, the control module 19 receives the signal that is sent by the surface recognition module and indicates that the non-working surface is detected, that is, determines whether the preset position relationship is met. In an embodiment, when the signal that is sent by the surface recognition module 9 and indicates that the non-working surface is detected is received, the control module 19 may acquire more information form the signal to help determine the positions of the autonomous lawnmower 1 and the boundary 3. If the preset position relationship is not met, the autonomous lawnmower continues walking and receives the signal, and if the preset relationship is met, steering is started.

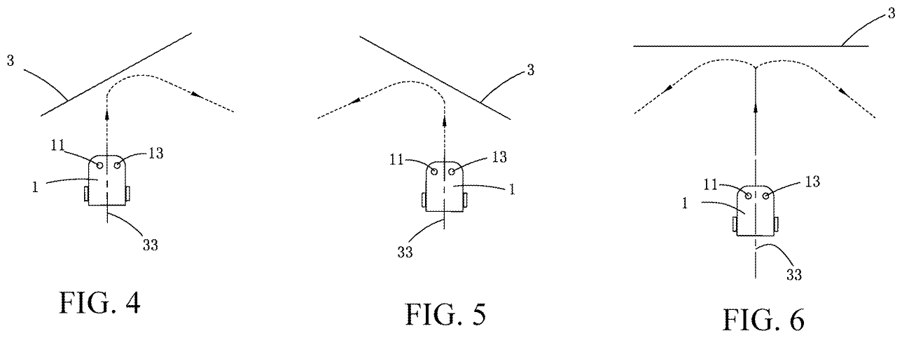

As shown in FIG. 4 to FIG. 6, in an embodiment, the surface recognition module 9 includes two surface recognition sensors. A surface recognition sensor 11 and a surface recognition sensor 13 are symmetrically disposed with respect to an axis 33 in the moving direction of the autonomous lawnmower 1. The moving direction of the autonomous lawnmower 1 herein is a direction of the autonomous lawnmower 1 walking in a straight line, and generally coincides with a longitudinal direction of the autonomous lawnmower 1. The axis in the moving direction of the autonomous lawnmower 1 is not unique, and the axis may be the central axis of the housing 21 or an axis parallel to the central axis. The surface recognition sensor 11 and the surface recognition sensor 13 are respectively located on the left and right sides of the axis. If the surface recognition sensor 11 on the left side first detects the non-working surface, the control module 19 determines that the left side in the moving direction of the autonomous lawnmower 1 is closer to the boundary 3, that is, the moving direction of the autonomous lawnmower 1 forms an acute angle with the boundary 3 in the clockwise direction. The control module 19 controls the drive wheel 23 to steer right, that is, the autonomous lawnmower 1 steers clockwise, so that when steering is completed, the moving direction of the autonomous lawnmower 1 forms an acute angle with the boundary 3 in the clockwise direction. If the surface recognition sensor 13 on the right side first detects the non-working surface, the control module 19 determines that the right side in the moving direction of the autonomous lawnmower 1 is closer to the boundary 3, that is, the moving direction of the autonomous lawnmower 1 forms an obtuse angle with the boundary 3 in the clockwise direction. The control module 19 controls the drive wheel 23 to steer left, that is, the autonomous lawnmower 1 steers counterclockwise, so that when steering is completed, the moving direction of the autonomous lawnmower 1 forms an obtuse angle with the boundary 3 in the clockwise direction. If the surface recognition sensor 11 and the surface recognition sensor 13 simultaneously detect the non-working surface, the control module 19 determines that the moving direction of the autonomous lawnmower 1 forms a right angle with the boundary 3, and the control module 19 controls the autonomous lawnmower 1 to steer clockwise or counterclockwise, so that the moving direction of the autonomous lawnmower 1 forms an acute angle, a right angle or an obtuse angle with the boundary 3. After the control module 19 receives the detection signal sent by the surface recognition module 9, no matter how the autonomous lawnmower 1 steers, when steering is completed, the moving direction of the autonomous lawnmower 1 is in the working area 7.

It should be noted that the boundary 3 may be curved on the whole, but the boundary 3 may be considered as a straight line near a specific intersection point. In other words, although the boundary 3 may be curved, when a preset position at which steering is determined is reached, from the intersection point of the moving direction of autonomous lawnmower 1 and the boundary 3, an extension direction of the boundary 3 is a straight line, and the extension direction is tangent to the boundary 3. To more accurately determine an intersection point, in this embodiment, the moving direction of the autonomous lawnmower 1 may be a direction line coinciding with the axis on which the surface recognition sensor 11 or the surface recognition sensor 13 is located.

In this embodiment, a steering angle of the autonomous lawnmower 1 is fixed, and is greater than or equal to 90 degrees and less than 180 degrees, and in an example embodiment is slightly greater than 90 degrees, that is, between 90 degrees and 120 degrees. The reason why the steering angle is greater than or equal to 90 degrees is to ensure that when a specific angle value of the foregoing acute angle is not clear, the autonomous lawnmower steers and travels into the boundary 3, and if the angle value can be determined, an appropriate steering angle within 180 degrees may be correspondingly selected according to the value of the acute angle. In this embodiment, if the moving direction of the autonomous lawnmower 1 forms an acute angle with the boundary 3 in the clockwise direction at the beginning of steering, the autonomous lawnmower 1 rotates clockwise by fixed degrees. Throughout the rotation until the rotation ends, an angle between the moving direction of the autonomous lawnmower 1 and the boundary 3 in the clockwise direction remains an acute angle. During steering, it is ensured that the autonomous lawnmower 1 enters different working areas, so as to prevent the autonomous lawnmower 1 from staying in the same area, thereby improving the working efficiency.

In an embodiment, the autonomous lawnmower 1 includes one surface recognition sensor 11. The control module 19 acquires a position relationship between the autonomous lawnmower 1 and the boundary 3 according to a detection signal of the surface recognition sensor 11. In this embodiment, the control module 19 processes the detection signal sent by the surface recognition sensor 11, to acquire a position relationship such as a distance relationship and an angle relationship between the autonomous lawnmower 1 and the boundary 3.

In an embodiment, when the surface recognition sensor 11 detects the non-working surface, the control module 19 controls the walking module 17 to reverse a fixed distance and then steer by a fixed angle. After steering is completed, the walking module moves along a straight line until the surface recognition sensor 11 detects the non-working surface again, and records a distance by which the walking module moves along a straight line after steering. An angle value between the moving direction of the autonomous lawnmower 1 and the boundary 3 in the clockwise direction is calculated according to the distance by which the walking module moves along a straight line the fixed distance of reversing, and the fixed angle of steering. In this embodiment, the control module 19 may determine a relationship of an acute angle, a right angle or an obtuse angle according to the angle value, so as to start the steering by the fixed angle. In another embodiment, specific angle values correspond to different steering angles, and the control module performs steering by corresponding angles according to different angle values, thereby further improving the working efficiency.

In an embodiment, the surface recognition module 9 includes a capacitive sensor mounted below the housing 21. When the autonomous lawnmower 1 is working, a capacitance C1 is formed between a probe of the capacitive sensor and a surface below the autonomous lawnmower 1. An electrical signal outputted by the capacitive sensor is related to a medium between two electrodes of the capacitor C1. When a surface below the probe is a non-lawn and when a surface below the probe is a lawn, the media between the two electrodes are different, and the electrical signals outputted by the capacitive sensor are different. In this way, the control module 19 can determine, according to different electrical signals outputted by the capacitive sensor, whether the surface below the probe is a lawn. In other words, the capacitive sensor determines, through contact detection, whether a surface walked by the autonomous lawnmower 1 is a working surface.

In an embodiment, the surface recognition module 9 includes two capacitive sensors symmetrically disposed with respect to an axis in the moving direction of the autonomous lawnmower 1. When any one of the capacitive sensors detects a lawn, the control module 19 determines the position relationship between the autonomous lawnmower 1 and the boundary 3. In this embodiment, since a distance between a detection area of the capacitive sensor and the walking module 17 is small, when the capacitive sensor detects the non-working surface, the control module 19 determines that the autonomous lawnmower 1 and the boundary 3 meet the preset position relationship. The control module 19 determines an angle relationship between the autonomous lawnmower 1 and the boundary 3 through a lawn/non-lawn signal sent by the left and right capacitive sensors, so as to control the steering. The specific control logic is described above.

In an embodiment, the surface recognition module 9 includes an optical sensor mounted above or in front of the housing 21. In this embodiment, an infrared light sensor and a visible light sensor are specifically included and detect the surface walked by the autonomous lawnmower 1. The infrared light sensor detects reflected light in an infrared wave band. The visible light sensor detects radiation light in a red light wave band. Whether the surface walked by the autonomous lawnmower 1 is a lawn is detected by calculating a vegetation index. The normalized difference vegetation index (NDVI) is used as an example. If an NDVI value is 0, it is determined that the surface is rock or bare soil without grass cover. If the NDVI value is greater than 0, NDVI values are different because of different vegetation coverage and vegetation types. For a normal working surface of the autonomous lawnmower 1, a specific interval may be set to determine a lawn/non-lawn.

In an embodiment, the surface recognition module 9 includes a radar sensor, mounted above or in front of the housing 21, and detecting the surface walked by the autonomous lawnmower 1 by transmitting and receiving an electromagnetic wave. In this embodiment, the radar sensor transmits and receives a millimeter wave, so that a water surface and a hard surface such as a tree root or a road surface can be detected, but grassed soil and grassless soil cannot be distinguished. Therefore, for a case that the non-working surface is a hard surface, the radar sensor may be used for detection, to distinguish the working surface from the non-working surface.

In an embodiment, the surface recognition module 9 includes an image sensor, mounted above or in front of the housing 21, capturing an image of the surface walked by the autonomous lawnmower 1, and detecting a lawn and a non-lawn by recognizing a feature such as color and texture. In some embodiments, the control module 19 processes, by using a deep learning algorithm, a detection signal sent by the image sensor, to recognize surfaces such as a lawn, a flower bed, and a road with different characteristics.

In an embodiment, the surface recognition module 9 includes an image sensor mounted on a longitudinal axis of the housing 21, and a detection area of the image sensor is symmetrical with respect to the longitudinal axis. In this embodiment, the longitudinal axis is a central axis of the housing 21, and in other embodiments, the longitudinal axis may be another axis parallel to the central axis. Therefore, the moving direction of the autonomous lawnmower 1 in an image shot by the image sensor coincides with a longitudinal axis of the image. The control module 19 may distinguish the working surface from the non-working surface according to a signal detected by the image sensor, and may further determine a position relationship between the image sensor and the boundary 3, the position relationship including a distance relationship, an angle relationship, and the like. If the moving direction of the autonomous lawnmower 1 forms an acute angle with the boundary 3 in the clockwise direction in the image, it means that the autonomous lawnmower 1 is close to the boundary 3, and the moving direction of the autonomous lawnmower 1 forms an acute angle with the boundary 3 in the clockwise direction. That is, an angle relationship between the boundary 3 and the autonomous lawnmower 1 in the image is consistent. In addition, a proportion of the non-working surface in the image shot by the image sensor is directly correlated to a distance between the autonomous lawnmower 1 and the boundary 3. According to a mounting height and angle of the image sensor, the distance between the autonomous lawnmower 1 and the boundary 3 may be recognized. Therefore, the control module 19 may determine, according to the detection signal sent by the image sensor, whether the autonomous lawnmower 1 and the boundary 3 meet the preset position relationship, control the walking module 17 to steer in a case that the preset position relationship is met, and control a specific steering manner based on the angle relationship between the autonomous lawnmower 1 and the boundary 3.

As described above, if the autonomous lawnmower 1 steers after encountering the boundary 3, danger may occur when the autonomous lawnmower enters the non-working area during steering. Therefore, the control module 19 needs to control the autonomous lawnmower 1 to remain in the working area 7. As shown in FIG. 3, in an embodiment, the distance between a detection area of the surface recognition module 9 and the walking module 17 is greater than a first preset distance. When the surface recognition module 9 detects the non-working surface, the control module 19 may determine a position relationship between the boundary 3 and the walking module 17 through a detection signal sent by the surface recognition module, and control the walking module 17 according to the position relationship to steer. Generally, in the case of the same steering angle and speed, in a direction perpendicular to the boundary 3, a maximum distance required for steering may be determined, and the first preset distance is greater than or equal to the maximum distance, so as to ensure that the walking module 17 does not exceed the boundary 3 during steering. On the other hand, if the detection area of the surface recognition module 9 is excessively far away from the walking module 17, the autonomous lawnmower 1 detects the non-working surface prematurely, and as a result the control module 19 may fail to accurately recognize the position relationship between the autonomous lawnmower 1 and the boundary 3. Therefore, when the first preset distance is slightly greater than or equal to the maximum distance, the working safety of the autonomous lawnmower 1 can be ensured, and a coverage rate of the autonomous lawnmower 1 in the working area 7 can be ensured. In this embodiment, the distance between the detection area of the surface recognition module 9 and the walking module 17 is between 20 cm and 80 cm.

Continuing to refer to FIG. 3, in an embodiment, an angle between a detection angle of the surface recognition module 9 and the height direction meets a preset angle range. If a mounting height of the surface recognition module 9 is determined, a specific detection angle corresponds to a specific detection area. The surface recognition module 9 is mounted to the housing 21. The housings 21 of different models of autonomous lawnmowers 1 have different sizes, walking speeds are different, different safety distances are required for steering the walking module 17, and corresponding detection angles are also different. If the angle between the detection angle and the height direction is excessively small, it cannot be ensured that the autonomous lawnmower 1 walks in the working area 7. If the angle between the detection angle and the height direction is excessively large, a distance between the surface recognition module 9 and a detected surface is excessively large, the recognition accuracy of the surface recognition module 9 may be affected, and the determination of the control module 19 on the position relationship between the autonomous lawnmower 1 and the boundary 3 may further be affected. Therefore, it is necessary to determine an appropriate detection angle according to the size of the housing 21, a mounting position of the surface recognition module 9, and the like. In this embodiment, the angle between the detection angle and the height direction of the surface recognition module 9 is less than 75 degrees and greater than 30 degrees.

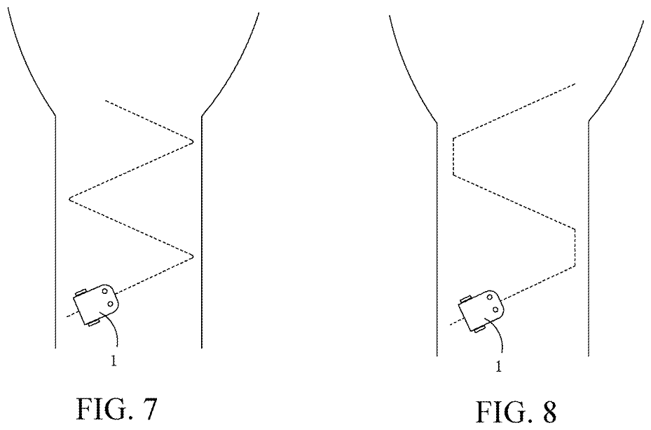

It should be noted that a steering manner of embodiments of the present invention is particularly beneficial during the passage in a narrow area. As shown in FIG. 7, after a path planning manner is used, an autonomous lawnmower 1 has directivity and may leave the narrow area after a limited number of times of moving back and forth. According to an actual calculation, it takes an average of 5 minutes to leave a typical narrow area without using the method, and when this method is used, it takes only half a minute.

As shown in FIG. 8, in an embodiment, to further optimize the speed of leaving the narrow area, the specific implementation of the present invention further provides another path planning manner. Such path planning manner implements fast departure from the narrow area by walking a particular distance along the boundary 3 after the boundary 3 is encountered. After approaching the boundary 3, the autonomous lawnmower 1 first slightly rotates to enable a walking direction to be consistent with an extension direction of the boundary 3, and then walks a preset distance in the extension direction of the boundary 3, and then steers inside the boundary 3 again. That is, after steering starts and before steering is completed, the autonomous lawnmower 1 walks a particular distance along the boundary. A specific manner of walking a particular distance may be a preset time or a second preset distance of walking of the autonomous lawnmower 1, and in an example embodiment the preset distance is 20 cm to 100 cm.

In an embodiment, the autonomous lawnmower 1 includes a surface recognition sensor mounted on a side surface of the housing 21 for detecting a walking surface of the walking module 17 on a side close to the boundary 3. The control module 19 acquires a surface in front of the walking module 17 and a surface on an outer side of the walking module 17 according to a detection result of the surface recognition module 9, and adjusts a moving direction of the walking module 17. In a walking process of the autonomous lawnmower 1, if the control module 19 receives the signal that is sent by the surface recognition module 9 and indicates that the non-working surface is detected, the position relationship between the autonomous lawnmower 1 and the boundary 3 is determined, and if the autonomous lawnmower 1 and the boundary 3 meet the preset position relationship, the walking module 17 is controlled to steer. If the moving direction of the autonomous lawnmower 1 forms an acute angle with the boundary 3, the autonomous lawnmower rotates clockwise by an acute angle, so that a surface detected by the surface recognition module 9 is a working surface, and a surface detected by the surface recognition sensor is a non-working surface, so that the autonomous lawnmower 1 walks a third preset distance along an inner side of the boundary 3. Next, an acute angle is rotated clockwise again, so that the autonomous lawnmower 1 walks inside the working area 7, and an angle between the moving direction of the autonomous lawnmower 1 and the boundary 3 is an acute angle.

The present invention is not limited to the structures of the specific embodiments described herein, and structures based on the concepts of the present invention shall fall within the protection scope of the present invention.

What is claimed is:

1. An autonomous lawnmower, walking and working in a working area, and wherein comprising:
a housing, comprising a front portion in a moving direction of the autonomous lawnmower;
a walking module, mounted in the housing, and driving the autonomous lawnmower to walk and steer;
a surface recognition module, mounted in the housing, and detecting a surface walked by the autonomous lawnmower, a detection area of the surface recognition module comprising a surface in front of the walking module; a surface in the working area being a working surface, a surface outside the working area being a non-working surface, a boundary of the working area being formed between the working surface and the non-working surface;
an energy module, mounted in the housing, and supplying energy to the autonomous lawnmower; and
a control module, electrically connected to the walking module and the surface recognition module, determining a position relationship between the autonomous lawnmower and the boundary according to a signal sent by the surface recognition module, if a preset position relationship is met, enabling the walking module to perform steering to travel into the working area; and
if the moving direction forms an acute angle with the boundary in the clockwise direction, steering is clockwise, so that when steering is completed, the moving direction forms an acute angle with the boundary in the clockwise direction, and if the moving direction forms an obtuse angle with the boundary in the clockwise direction, steering is counterclockwise, so that when steering is completed, the moving direction forms an obtuse angle with the boundary in the clockwise direction.

2. The autonomous lawnmower according to claim 1, wherein the surface recognition module recognizes a lawn.

3. The autonomous lawnmower according to claim 2, wherein the surface recognition module comprises a surface recognition sensor, and the surface recognition sensor comprises at least one of an optical sensor, a radar sensor, a capacitive sensor, and an image sensor.

4. The autonomous lawnmower according to claim 1, wherein during steering, the control module controls the walking module to keep walking in the working area.

5. The autonomous lawnmower according to claim 4, wherein a distance by which the detection area exceeds the walking module is greater than or equal to a first preset distance.

6. The autonomous lawnmower according to claim 5, wherein the first preset distance is between 20 cm and 80 cm.

7. The autonomous lawnmower according to claim 4, wherein an angle between a detection angle of the surface recognition sensor and the height direction is less than 75 degrees and greater than 30 degrees.

8. The autonomous lawnmower according to claim 4, wherein according to a signal that is sent by the surface recognition module and indicates that the non-working surface is detected, the control module controls the walking module to reverse a second preset distance and then steer.

9. The autonomous lawnmower according to claim 1, wherein the surface recognition module comprises at least one of a surface recognition sensor, and a detection area of the surface recognition sensor is symmetric with respect to an axis in the moving direction.

10. The autonomous lawnmower according to claim 9, wherein the surface recognition module comprises an image sensor, and the control module determines an angle relationship between the moving direction and the boundary in the clockwise direction according to a relative relationship, detected by the image sensor, between the axis and the boundary.

11. The autonomous lawnmower according to claim 1, wherein the surface recognition module comprises at least two surface recognition sensors symmetrically disposed with respect to an axis in the moving direction.

12. The autonomous lawnmower according to claim 11, wherein if a surface recognition sensor on the left side of the axis first detects the non-working surface, the control module determines that the moving direction forms an acute angle with the boundary in the clockwise direction; and if a surface recognition sensor on the right side of the axis first detects the non-working surface, the control module determines that the moving direction forms an obtuse angle with the boundary in the clockwise direction.

13. The autonomous lawnmower according to claim 1, wherein an angle of steering is less than 180 degrees and greater than or equal to 90 degrees.

14. The autonomous lawnmower according to claim 1, wherein the walking module comprises at least two drive wheels, each drive wheel is connected to an independent drive motor, and during steering, the drive motors drive the two drive wheels at different speeds or in different directions.

15. A steering method of an autonomous lawnmower, wherein the autonomous lawnmower is configured to walk and work in a working area defined by a boundary formed by a lawn and a non-lawn, a surface in the working area is a lawn, and the method comprises the following steps:
traveling, by the autonomous lawnmower, to the boundary;
detecting a surface walked by the autonomous lawnmower;
determining a position relationship between the autonomous lawnmower and the boundary based on the detection of a non-lawn; and
determining an angle relationship between the autonomous lawnmower and the boundary, when the position relationship between the autonomous lawnmower and the boundary meets a preset position relationship, wherein
steering is controlled according to the angle relationship to enable the autonomous lawnmower to travel into the working area, if a moving direction of the autonomous lawnmower forms an acute angle with the boundary in the clockwise direction, steering is clockwise, so that when steering is completed, the moving direction forms an acute angle with the boundary in the clockwise direction, and if the moving direction forms an obtuse angle with the boundary in the clockwise direction, steering is counterclockwise, so that when steering is completed, the moving direction forms an obtuse angle with the boundary in the clockwise direction.

16. The steering method according to claim 15, wherein after steering is started and before steering is completed, the autonomous lawnmower walks a second preset distance along an inner side of the boundary.

17. The steering method according to claim 16, wherein the second preset distance is between 20 cm and 100 cm.
